(19) United States
(12) Patent Application Publication
(10) Pub. No.: US 2004/0186833 A1
(43) Pub. Date: Sep. 23, 2004

(54) Requirements -based knowledge discovery for technology management

(75) Inventor: Robert J. Watts, St. Clair Shores, MI (US)

Correspondence Address: U.S. ARMY TACOM, ATTN: AMSTA-LP, 6501 E. 11 MILE ROAD, WARREN, MI, 48397-5000, US

(73) Assignee: The United States of America as represented by the Secretary of the Army, Washington, DC

(21) Appl. No.: 10/392,484

(22) Filed: Mar. 19, 2003

(51) Int. Cl. G06F 17/30; G06F 7/00

(52) U.S. Cl. 707/5

(57) ABSTRACT

A technique for mining data to generate clusters of records that are related from data sets which may have an organization different from the relationships sought to be explored. The records are then clustered into sets which show they are connected by one or more common ideas.

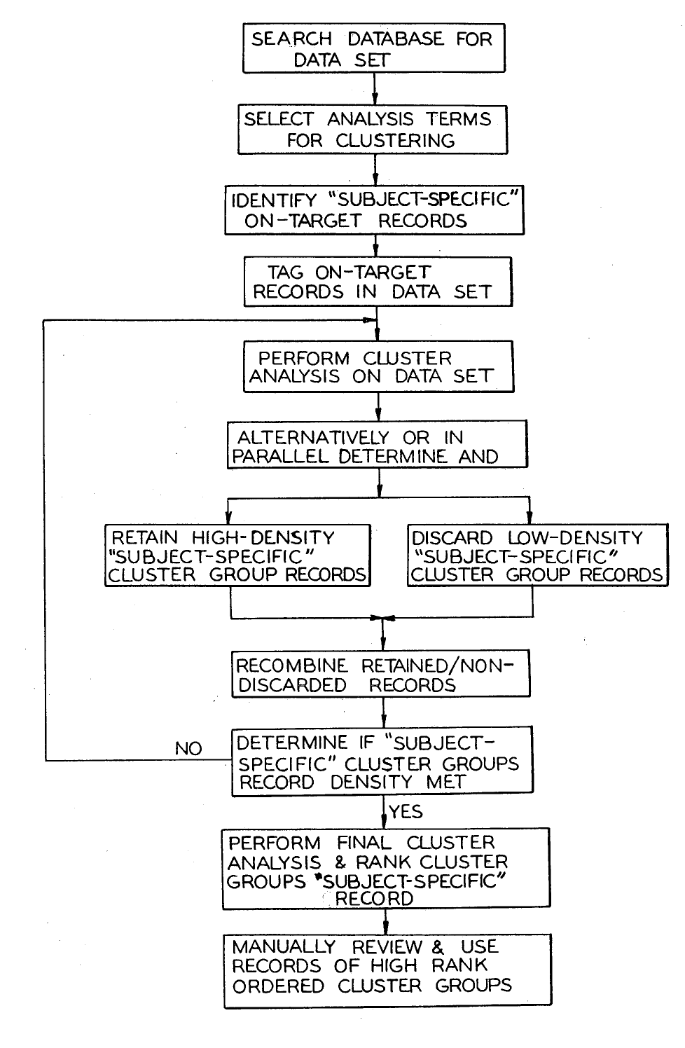

### 1. GOVERNMENT INTEREST

2. The invention described here may be made, used and licensed by and for the United States Government for governmental purposes without paying me any royalty.

### 3. BACKGROUND OF THE INVENTION

4. Today's environment has many tools for generating and managing information. Because of the internet and other electronic media, much of the information generated is available in electronic format and thus amenable to computerized search and analysis. However, merely having the data available in electronic format does not imply that searching and analysis is simple or easy. Much of the information is subject to little or no organization. Further, when the number of records to be searched raises to a certain level, simply sorting or searching on normal terms is not meaningful. While information may be well organized and categorized, it may not be tagged for subject-of-interest specific searches or it may be organized differently than necessary for the data to be substantively analyzed. Lastly two or more data sets may use different lexicons.

5. An example of the possible differences can be shown by comparing the MEDLINE data base with the data base of issued patents. Each may be categorized, but the categories to be used are probably vastly different, since one is designed to help medical researchers and the other is designed to facilitate patentability searching. It is also expected that the lexicons of the two data sets would be different since they are different in focus and have different needs. Patents in particular will frequently deal with totally new concepts and require the use of words which are new or which must be used in new and unique ways.

### 6. SUMMARY OF THE INVENTION

7. This process uses a small set of most relevant records (i.e., sub-discipline subject specific documents) within a large data set of records, which represents a broader subject area to focus clustering analysis techniques, such that only clusters of the data set with a sufficient density of the most relevant records result from the analysis. The present invention is a way to use an improved data analysis clustering process for extracting and analyzing data from diverse data bases. As a first step, the data base to be analyzed is chosen. The data base will assumedly have data in reports which when searched using a subject area search term or phrase will generate a large set of records, the data set. Clustering using a subject specific sub-discipline within the subject area, may show relationships not readily apparent and which would take substantial time and effort to determine manually. For example, “subject area” might be “model predictive control” and the subject specific records relate to “constraints” or “constraint handling”. A search of the data base using the subject area model predictive control would be expected to retrieve a data set of several thousand records. A second search of the same data base using the subject area model predictive control combined with the logical operator “and” combined with the sub-discipline constraint handling would be expected to return a much smaller set of records say on the order of less than 50 records. The subject specific records from the second search are obviously a sub-set of the larger subject area data set from the first search. The present invention uses the subject specific records to focus the clustering of the subject area data set to identify records that relate to subject specific records but do not specifically use the subject specific terms and phrases.

8. Next the terms to be used in the analysis must be identified and selected. One method of selecting the analysis terms is to use a data base that has a well established index field. The data set clustering analysis is then based on the index field terms and phrases.

9. A second method of deriving the index (i.e. analysis) terms would be to apply a comparative analysis of term frequency in the data base versus the term frequency in data set of information to be analyzed. Terms having higher relative frequency in the data set than the data base would be considered to be the most relevant. Of course commonly occurring connectives and articles would be excluded.

10. A third method is the use of a subject matter specific thesaurus which would contain the terms and phrases normally used by the art.

11. Once the process for selecting the analysis terms has been identified, a search of the data base using the subject area terms is used to retrieve the data set. The subject specific records can be identified by a search of the data base or data set or manual selection. These subject specific records are tagged for use in identifying the indirectly related records from the data set chosen.

12. The records in the data set are next subjected to a cluster analysis using a clustering algorithm. The subject specific high density clusters are selected to form a high density record set; and a second clustering analysis is performed on the reduced-size data set. Alternatively, or in parallel, low density clusters can be excluded from the data set to form a reduced size data set; and a second clustering analysis is performed on the reduced size data set. This process is continued until a predetermined density of subject-specific record clusters is achieved. After the desired target density is achieved, a last cluster analysis is performed to select the records for manual review.

13. Common records to the high density and low density processed data record sets can be selected and merged to form a new set of selected records for analysis. The clustering algorithm is applied to the new set of records to create the final set of record clusters. The resultant final clusters which will have a high degree of relationship to each other and the starting tagged subject specific records, can then be individually reviewed and analyzed manually.

### 14. BRIEF DESCRIPTION OF THE DRAWINGS

15. In the accompanying drawing:

16. The FIGURE is a flow diagram of one process according to this invention.

### 17. DETAILED DESCRIPTION

18. Referring to the accompanying drawing the first step in the process is obtaining the data set to be analyzed from a data base. Where a specialized data base is available it will generally be selected to minimize the number of records to be analyzed. However this technique is also applicable to general data bases such as patent abstracts and can be used to retrieve those abstracts that have relevance to the subject matter sought. Once the desired data is identified, the data will be downloaded to a local computer for further processing.

19. Next the analysis terms must be identified. The technique of using an existing data base with a well established index field represents one good method. As an example one could use the MEDLINE data base with its acknowledged index procedures to review a number of articles and perform a clustering analysis on the data base. The results can then be reviewed to ascertain which index terms resulted in clusters of information that will be relevant for further analysis. From this initial run those terms that create clusters of useful data can be identified and use of a small sample size allows a relatively quick review of the results. The terms that do create useful data or describe desired relationships among the sample data items are then used in analyzing the larger data set.

20. A portion of the data set is selected using a refined, detailed search on terms that are directly on point. This is designed to generate a small subject specific sample, say less than 5% of the total documents that have index terms defining the very kernel of the data set to be analyzed. These “on target” records are tagged and their constituent index terms can be used to identify the indirectly related records in the data set.

21. Next the records in the data base are subjected to a cluster analysis using a clustering algorithm. Clustering algorithms are known in the art. One example is principal components analysis (PCA). In a PCA analysis the relatedness of the terms and phrases within the document are used to create groups, the members of each group being more related to each other than to the other members of the data set. For a first analysis the subject specific records highest density clusters are selected to form a high density record set. A second PCA analysis is performed on the original data set and the subject specific lowest density clusters are excluded from the original data set to form a low density record set. A one tailed T test with varying confidence levels is used; the confidence level is chosen to control the focusing of the data set size reduction. If the data set is not contracting sufficiently the process will increase the confidence level of the test in small increments until the data set size reduces.

22. The high density and low density processed data sets from the previous PCA runs are each subjected to a second PCA analysis using the respective high and low cluster density techniques. The steps are repeated until the resulting clusters reach a predetermined level of density of the subject specific records set by the program or manually entered.

### 23. EXAMPLE

24. A search was developed focusing on the technology domain of advanced materials for automotive uses, i.e. automotive lightweight materials. The data to be mined was recent U.S. Patents. Commercial research and development data bases, EI Compendex and INSPEC were searched for research and development abstracts containing the phrase “lightweight materials” and either automobile or automotive. This same search applied to the U.S. Patents database, yielded 2185 possible patents to be reviewed. Obviously such a review would be both expensive and consume large amounts of valuable engineering time.

25. Having selected a data set for analysis, the next step is the selection of analysis terms to be applied to the data. For this purpose 82 abstracts from the EI Compendex and INSPEC research and development data bases that had an index field in the constituent records which related to light weight automotive materials and further containing the term magnesium. Magnesium represents a subject specific sub-discipline of the generic subject, automotive light weight material.

26. From the 82 abstracts a list of terms or descriptors from the records index field that appeared 3 or more times Was generated to serve as a surrogate thesaurus of the subject specific area of interest, i.e. magnesium automotive lightweight materials.

27. A natural language processing technique was applied to the abstracts of the 2185 patents to extract noun phrases to serve as analysis terms. This process generated a number of frequently occurring noun phrases. The noun phrase listing was compared to the surrogate thesaurus list of terms to eliminate those phrases and terms that were considered superfluous to the analysis, including terms such as plurality, uses, methods, etc.

28. Next the patent abstract noun phrases common to the 82 research and development abstract index terms were used to create cluster groups of the patent abstracts. The result was 1227 patents grouped into clusters that contained content. The resulting groups would contain relationships based on empirical relationships without the preordained ideas of what patents might be related.

29. Of course review of 1227 patents would be a large undertaking and would require review of many patents which were not related to the subject specific focus of what role magnesium might play in automotive design. Therefore, a subject specific set of patents, (15 patents) which specifically contained the term magnesium, was used to focus continued clustering to further refine the relationships between the patents. The first iteration resulted in 18 different categories. After the groups with negligible count of the subject specific focus group records were eliminated, there were 382 records. Examples of groups that were eliminated include: other, surfaces. Thermoplastics, cutting steel, stresses. After a second analysis, the new groups were examined and again the groups with little relevance eliminated. The final clustering result was 268 patent abstracts in seven groups, five of which contained 158 patents that have maximum relevance to automotive light weight materials with potential magnesium use considerations.

30. Various alterations and modifications will become apparent to those skilled in the art without departing from the scope and spirit of this invention and it is understood this invention is limited only by the following claims.

What is claimed is:

1. A data analysis clustering process for extracting and analyzing data comprising the steps of:
choosing a data base to be analyzed for possible correlations;
selecting tag terms to depict the content for analysis;
performing a preliminary search of the data base using a limited number specific terms to select a small number of data records which will be highly relevant to the subject matter sought;
performing a cluster analysis on the data base and selecting the high density clusters to from a high density record set;
performing a second analysis on the data base and excluding the low density clusters; to form a low density record set;
repeating the high density and low density analysis and respective data sets until a predetermined density of record clusters is achieved;
consolidating to a final data set using common records from the high density and low density record sets;
performing a last cluster analysis to select the records for manual review;
analyzing the resulting clusters which will have a high degree or relationship to each other and the starting tagged terms.

2. The data analysis system of claim 1 wherein the step of selecting tag terms is performed by analyzing a second indexed data base to determine the relevant terms in the data base to be analyzed and then further subjecting the tagged terms to a zipf distribution analysis to select the most relevant terms to be clustered.

3. The data clustering process of claim 1 wherein the step of selecting the tagged terms is conducted using a term frequency distribution analysis (tf-idf).

4. The data clustering process of claim 1 wherein the step of selecting the tagged terms is conducted using a, subject matter thesaurus application to select and consolidate tagged terms.
